(19) United States
(12) Patent Application Publication
(10) Pub. No.: US 2017/0360651 A1
(43) Pub. Date: Dec. 21, 2017

(54) MASSAGE UNIT AND MASSAGE MACHINE

(71) Applicant: FUJI MEDICAL INSTRUMENTS MFG. CO., LTD., Osaka (JP)

(72) Inventors: Nobukazu KAWAGOE, Osaka-shi (JP); Toshihisa YOSHIDA, Osaka-shi (JP); Takuji SOGA, Osaka-shi (JP)

(73) Assignee: FUJI MEDICAL INSTRUMENTS MFG. CO., LTD., Osaka (JP)

(21) Appl. No.: 15/624,606

(22) Filed: Jun. 15, 2017

(30) Foreign Application Priority Data
Jun. 16, 2016 (JP) 2016-119811

(51) Int. Cl. A61H 15/00; A61H 23/02; A61H 7/00; A61H 23/00

(52) U.S. Cl. CPC A61H 15/0078; A61H 23/006; A61H 23/02; A61H 7/007; A61H 2201/123; A61H 2007/009; A61H 2201/1623; A61H 2201/1664; A61H 2201/1671; A61H 2201/1215

(57) ABSTRACT

It is a primary object of the present invention to provide a massage unit and a massage machine which can increase a protruding amount of a massage ball. A massage unit 700 includes a pair of massage elements 350; a forward-backward axis 722 forming a swinging fulcrum point for moving the pair of massage elements 350 toward a body of a person to be treated; and an up-and-down axis 732 for moving the massage unit, wherein the forward-backward axis 722 is formed in parallel with the up-and-down axis 732 and provided nearer to the side of the body of the person to be treated than the up-and-down axis 732.

This application claims priority under 35 U.S.C. §119 to Japanese patent application Serial No. 2016-119811, filed Jun. 16, 2016, which is incorporated herein by reference in its entirety.

### FIELD OF INVENTION

The present invention relates to a massage unit and a massage machine.

### BACKGROUND OF THE INVENTION

In JP 2002-159549A (patent document 1), there is disclosed a massage machine which can significantly change a protruding amount of a massage ball in a conventional massage machine.

### SUMMARY OF THE INVENTION

According to one aspect of the present invention, a massage unit includes:

a massage element;

a forward-backward axis forming a swinging fulcrum point for moving the massage element toward a body of a person to be treated; and

an up-and-down axis provided so as to extend in a width direction thereof for moving the massage unit up and down,

wherein the forward-backward axis is formed in parallel with the up-and-down axis and provided nearer to the side of the body of the person to be treated than the up-and-down axis.

According to another aspect of the present invention, a massage machine includes:

the massage unit defined by claim 1; and

an up-and-down motor interlocked and coupled with the up-and-down axis and elevating the massage unit along a body supporting portion for the person to be treated.

### BRIEF DESCRIPTION OF DRAWINGS

FIG. 1 is a perspective view showing a configuration of a massage machine according to an embodiment of the present invention.

FIG. 2 is a schematic view of a partial cutout showing a structure of a backrest portion of the massage machine.

FIG. 3 is a schematic view showing one example of a configuration of a massage unit.

FIG. 4 is a schematic view showing one example of an outline of a structure of the massage unit.

FIG. 5 is another schematic view showing the one example of the outline of the structure of the massage unit.

FIG. 6 is a schematic view showing one example of an outline of a state that a massage ball unit mechanism protrudes from the massage unit of the massage machine according to the present embodiment.

FIG. 7 is another schematic view showing the one example of the outline of the state that the massage ball unit mechanism protrudes from the massage unit of the massage machine according to the present embodiment.

FIG. 8 is a schematic view showing one example of an outline of a state that a massage ball unit mechanism protrudes from a conventional massage unit.

FIG. 9 is another schematic view showing the one example of the outline of the state that the massage ball unit mechanism protrudes from the conventional massage unit.

### DETAILED DESCRIPTION OF THE PREFERRED EMBODIMENT

Hereinafter, an embodiment of the present invention will be described in detail with reference to the accompanying drawings. The same numbers are used throughout the drawings to reference the same objects or the equivalent objects and description for the same objects or the equivalent objects is not repeated. For ease of explanation, configurations are shown in the drawings referenced in the following description in a simplified or schematized manner and/or some of configuration members are omitted in the drawings. Further, a dimensional ratio among the configuration members shown in each drawing does not necessarily indicate an actual dimensional ratio.

### Aspect of Embodiment

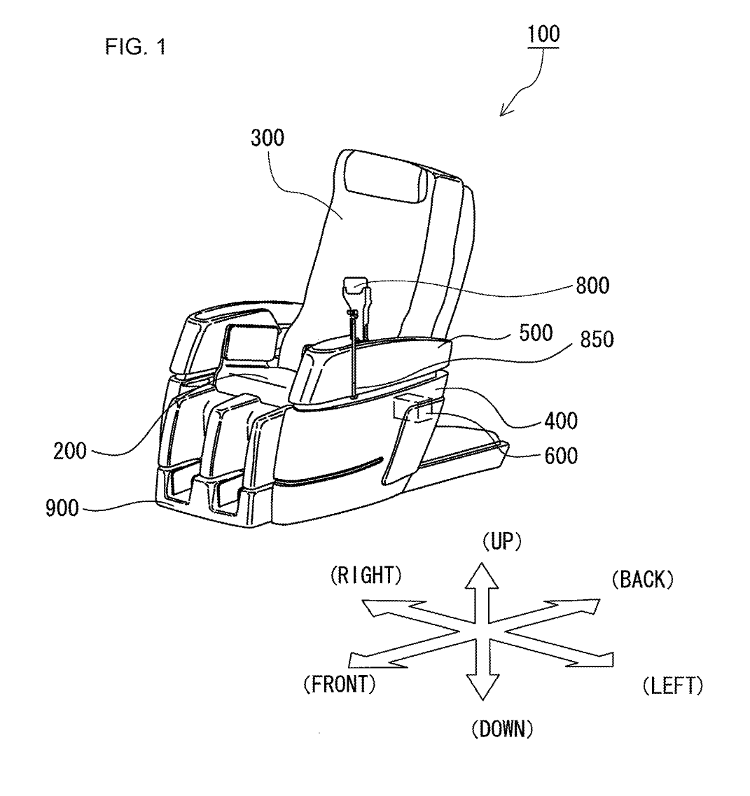

FIG. 1 is a perspective view showing a configuration of a massage machine 100 according to the embodiment of the present invention. As shown in FIG. 1, the massage machine 100 according to the embodiment of the present invention includes a seat portion 200, a backrest portion 300, a base portion 400, arm treating portions 500, an operation part 800, a stand 850 and leg placing portions 900.

In this regard, in the following description for the massage machine 100, the side on which the backrest portion 300 is formed on the seat portion 200 is assumed as a back side (BACK), the side opposed to the back side (BACK) is assumed as a front side (FRONT), each of a left side (LEFT) and a right side (RIGHT) is assumed and each of an upside (UP) and a down side (DOWN) is assumed as shown in FIG. 1.

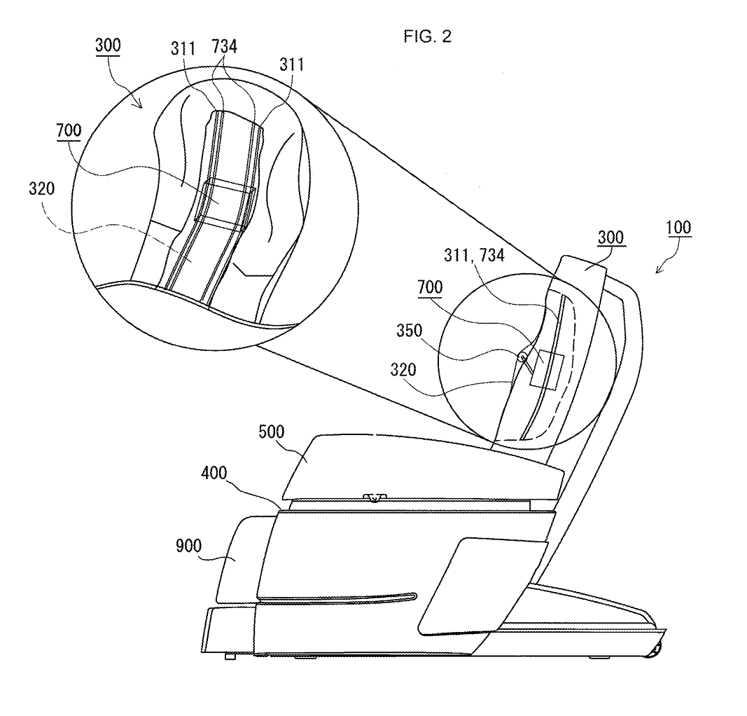

As shown in FIG. 1, the backrest portion 300 of the massage machine 100 is formed so that the backrest portion 300 can support a shoulder, a waist and a back of the person to be treated and can be erected and tilted in the front-back direction. Further, massage elements (a pair of massage balls) 350 (see FIG. 2) are provided in the backrest portion 300 so that the massage elements 350 can be moved in the up-and-down direction along guide rails 311 (see FIG. 2). The massage elements 350 are constituted of the pair of massage balls 350 so as to be capable of performing a variety of treatment operations such as a kneading operation, a beating operation and a rolling operation.

One or more expansion and contraction bags (air treatment portions) (not shown in the drawings) which can repeatedly expand are provided in the seat portion 200 and a hip of the person to be treated is supported and treated by the expansion and contraction bags. Further, the leg placing portions 900 are pivotally supported at front ends of the seat portion 200 and the base portion 400 and provided so that each leg placing portions 900 itself can be pivotally moved. One or more expansion and contraction bags (not shown in the drawings) which can repeatedly expand are provided in the leg placing portions 900 and legs of the person to be treated are treated by the expansion and contraction bags.

Further, the arm treatment portions 500 are respectively provided to stand on the left and right sides on the seat portion 200 shown in FIG. 1. One or more expansion and contraction bags (not shown in the drawings) which can repeatedly expand are provided in each of the arm treatment portions 500 and arms of the person to be treated are supported and treated by the expansion and contraction bags.

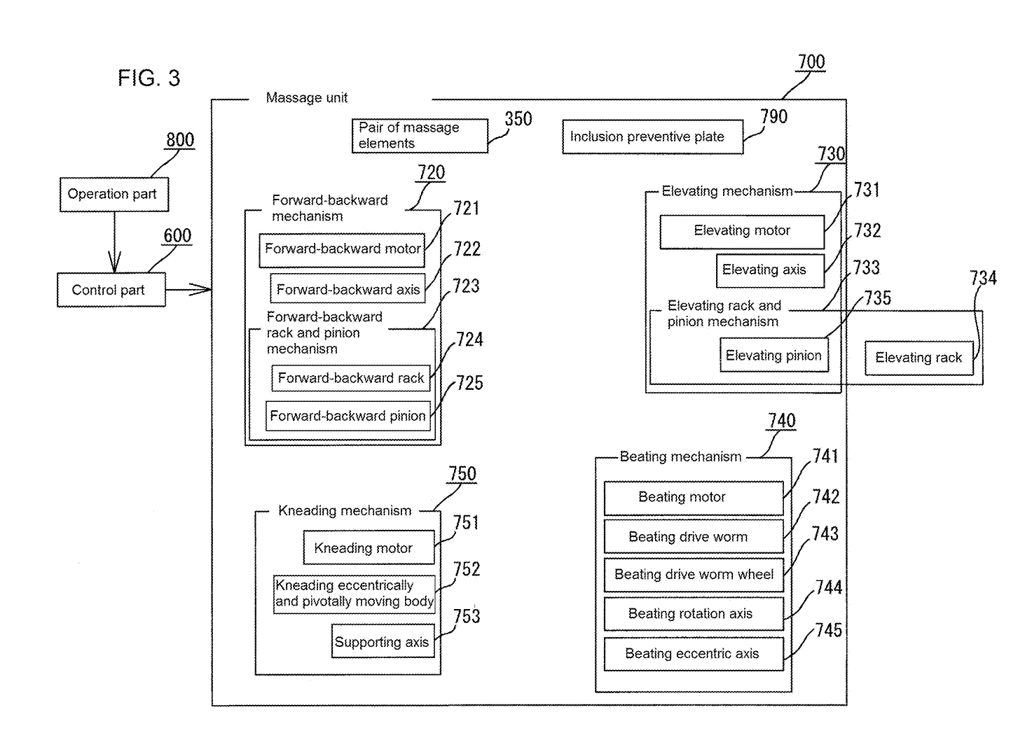

Next, FIG. 2 is a schematic view of a partial cutout showing a structure of the backrest portion 300 of the massage machine 100. As shown in FIG. 2, the pair of guide rails 311 and an up-and-down rack 734 of an up-and-down rack and pinion mechanism 733 (see FIG. 3) are provided in the backrest portion 300 of the massage machine 100. The massage unit 700 moves along the guide rails 311. Further, an up-and-down pinion 735 (see FIG. 3), which can mesh with the up-and-down rack 734 of the up-and-down rack and pinion mechanism 733, is provided in the massage unit 700.

Further, a cover member 320 made of a cloth member is provided at a portion of the backrest portion 300 to which the back of the person to be treated contacts, specifically, a portion of the backrest portion 300 to which the person to be treated reclines. The cover member 320 is a member for blocking an opening portion formed in an area in which the pair of massage elements 350 can move and preventing a part of the body of the person to be treated from moving toward the side of the pair of massage elements 350 through the opening portion.

In this embodiment, a surface of the cover member 320 is formed from a fibrous material such as velour. Further a rear surface of the cover member 320 is formed from a polyamide resin. In this regard, although description is given to the above material for the cover member 320 in this embodiment, the cover member 320 is not limited thereto. For example, the cover member 320 may be formed from leather, artificial leather, a variety of other synthetic resin, a fibrous material, a composite material of them and the like.

In this regard, although description for this matter is omitted in this embodiment, it may be possible to prevent the back of the person to be treated from moving into the opening portion with not only the cover member 320 but also a supporting belt which can support the back of the person to be treated and the like.

Next, description will be given to a massage unit 700 and then description will be given to a protruding amount of the pair of massage elements 350 protruding from the massage unit 700.

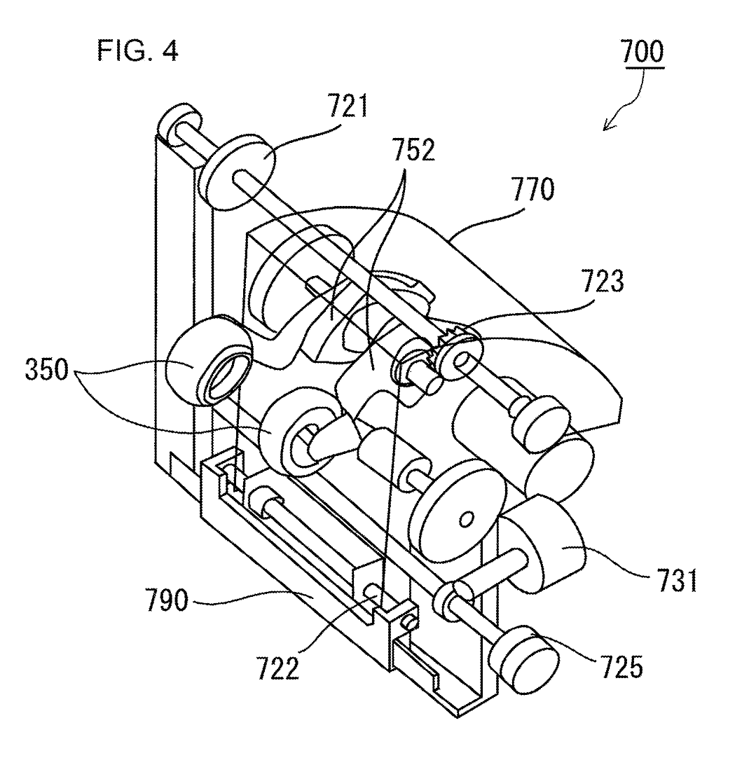

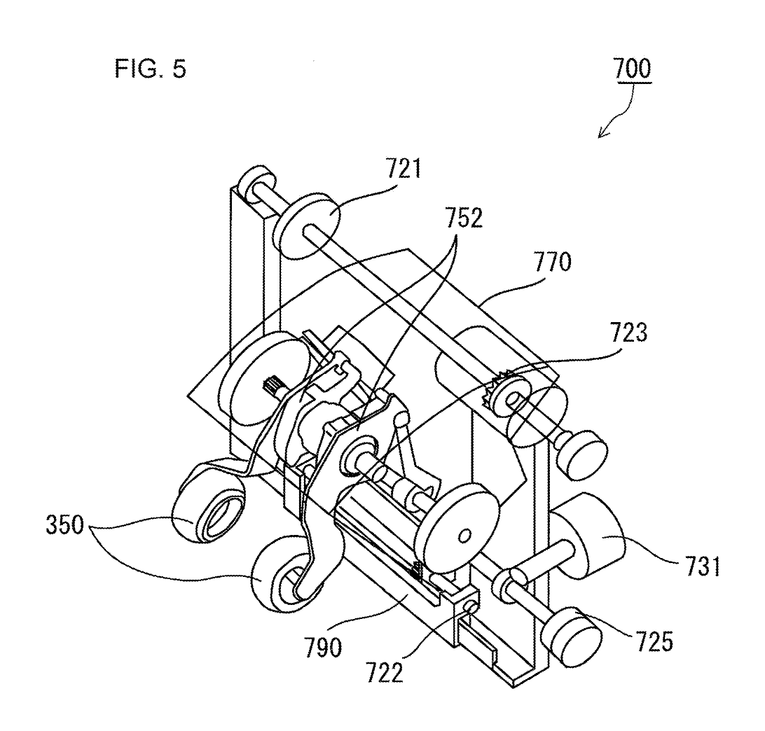

FIG. 3 is a schematic view showing one example of a configuration of the massage unit 700. Each of FIGS. 4 and 5 is a schematic view showing one example of an outline of a structure of the massage unit 700. In this regard, although the massage unit 700 is exemplified in this embodiment, the massage unit 700 is not limited thereto. The massage unit 700 may not be unitized.

The massage unit 700 shown in FIGS. 3 to 5 mainly has the pair of massage elements 350, a forward-backward mechanism 720, an up-and-down mechanism 730, a beating mechanism 740 and a kneading mechanism 750.

As shown in FIG. 3, the massage unit 700 operates according to an instruction from a control part 600 corresponding to an operation of the person to be treated with respect to the operation part 800. Thus, the control part 600 controls each of operations of a forward-backward motor 721 of the forward-backward mechanism 720, an up-and-down motor 731 of the up-and-down mechanism 730, a beating motor 741 of the beating mechanism 740 and a kneading motor 751 of the kneading mechanism 750. As a result, each mechanism drives and the pair of massage elements 350 provide a massage to the person to be treated. In this regard, although the massage unit 700 of the seat-type massage machine 100 according to this embodiment has a width adjusting mechanism, description for the width adjusting mechanism is omitted from the description for the present invention.

As shown in FIGS. 3 to 5, a part of the forward-backward mechanism 720, the up-and-down mechanism 730 and the massage ball unit mechanism 770 are provided in the massage unit 700. Another part of the forward-backward mechanism 720, the beating mechanism 740 and the kneading mechanism 750 are provided in the massage ball unit mechanism 770.

(Forward-Backward Mechanism 720)

Next, description will be given to each mechanism. First, the forward-backward mechanism 720 is described. As shown in FIGS. 3 to 5, the forward-backward mechanism 720 includes the forward-backward motor 721, a forward-backward axis 722 and a forward-backward rack and pinion mechanism 723. The forward-backward rack and pinion mechanism 723 contains a forward-backward rack 724 and a forward-backward pinion 725.

The forward-backward rack 724 of the forward-backward rack and pinion mechanism 723 of the forward-backward mechanism 720 is provided on the side of an upper portion of the massage ball unit mechanism 770 and the forward-backward pinion 725 is provided on the side of the massage unit 700. Further, the forward-backward axis 722 is provided on a lower end side of the massage unit 700 and a lower end side of the massage ball unit mechanism 770.

As a result, when the forward-backward rack and pinion mechanism 723 drives around the forward-backward axis 722 as a rotational axis, the massage ball unit mechanism 770 protrudes with respect to the massage unit 700. Further, as shown in FIGS. 3 to 5, both end sides of the forward-backward axis 722 are pivotally supported by an inclusion preventive plate 790 of the cover member 320.

(Up-and-Down Mechanism 730)

Next, the up-and-down mechanism 730 has the up-and-down motor 731 and an up-and-down axis 732. When the up-and-down motor 731 normally rotates, the up-and-down axis 732 rotates and the rotation is transferred to a pinion gear and a rack (not shown in the drawings), and thereby the massage unit 700 moves in the upper direction. Further, when the up-and-down motor 731 inversely rotates, the up-and-down axis 732 rotates and the rotation is transferred to the up-and-down pinion 735 of the up-and-down rack and pinion mechanism 733, and thereby the massage unit 700 moves in the lower direction. As a result, it is possible to move the pair of massage elements 350 in one direction of the upper and lower directions. Thus, by moving the pair of massage elements 350 in the upper direction, it is possible to massage an upper portion of the back of the person to be treated and by moving the pair of massage elements 350 in the lower direction, it is possible to massage a lower portion of the back or a waist portion of the person to be treated.

(Beating Mechanism 740)

Next, the beating mechanism 740 includes the beating motor 741, a beating drive worm 742, a beating drive worm wheel 743, a beating rotational axis 744 and beating eccentric axes 745.

In the beating mechanism 740, the beating rotational axis 744 extending in a left-right width direction is pivotally attached in the massage ball unit mechanism 770. The beating drive worm wheel 743 is attached on the side of an end portion of the beating rotational axis 744. The beating drive worm 742 is provided so as to mesh with the beating drive worm wheel 743. Further, the beating eccentricity axes 745 are respectively provided on both end portions of the beating rotational axis 744 in a state that the beating eccentric axes 745 are eccentric with respect to an axial core of the beating rotational axis 744.

As a result, when the beating motor 741 drives, the beating worm drive 742 rotates. When the beating drive worm 742 rotates, the beating drive worm wheel 743 is moved. The beating drive worm wheel 743 performs an eccentric operation due to the beating eccentric axes 745 and the beating rotational axis 744. As a result, the pair of massage elements 350 perform the beating operation.

(Kneading Mechanism 750)

The kneading mechanism 750 has the kneading motor 751, a kneading eccentrically and pivotally moving body 752 and a supporting axis 753. As a result, when the kneading motor 751 drives, the pair of massage elements 350 eccentrically and pivotally move in the front-back direction due to the kneading eccentrically and pivotally moving body 752 provided at the supporting axis 753 to perform the kneading operation. As a result, the pair of massage elements during the kneading operation is eccentrically and pivotally moved in the front-back direction, thus the kneading operation contains all of a movement in the up-down direction, a movement in the front-back direction and a movement in the left-right direction, and thereby an abutting angle of the massage elements (the massage balls) with respect to the body also changes. In this regard, in this embodiment, description for a kneading drive worm wheel, a kneading drive worm, a kneading drive pulley, a kneading following pulley and a transmission belt is omitted.

(Pair of Massage Elements)

The pair of massage elements 350 are attached in a sloped state that upper end portions of a pair of left-right massage ball arm supporting bodies are directed toward an outward direction at left-right end portions of a kneading axis. Further, tip end portions of interlocking arms are respectively interlocked and coupled to back portions of the massage ball arm supporting bodies to attach base end portions of the interlocking arms to a beating eccentric axis. Further, the base end portions of the massage ball supporting arms are attached to front side upper portions of the massage ball arm supporting bodies and the pair of massage elements (massage balls) 350 are pivotally attached to tip end portions of the massage ball supporting arms. In this regard, in this embodiment, although the pair of massage elements 350 are constituted of two massage elements, the present invention is not limited thereto. The technic of the present invention can be applied to any number of massage elements such as one massage element, three massages elements, four massage elements, five massage elements, six massage elements and the like.

(Protruding amount due to a relationship between the forward-backward axis and the up-and-down axis)

Subsequently, description will be given to a relationship between the forward-backward axis and a protruding amount of the pair of massage elements and a relationship between the forward-backward axis and a protruding amount in a state that the forward-backward axis and the up-and-down axis are commonly used in this embodiment.

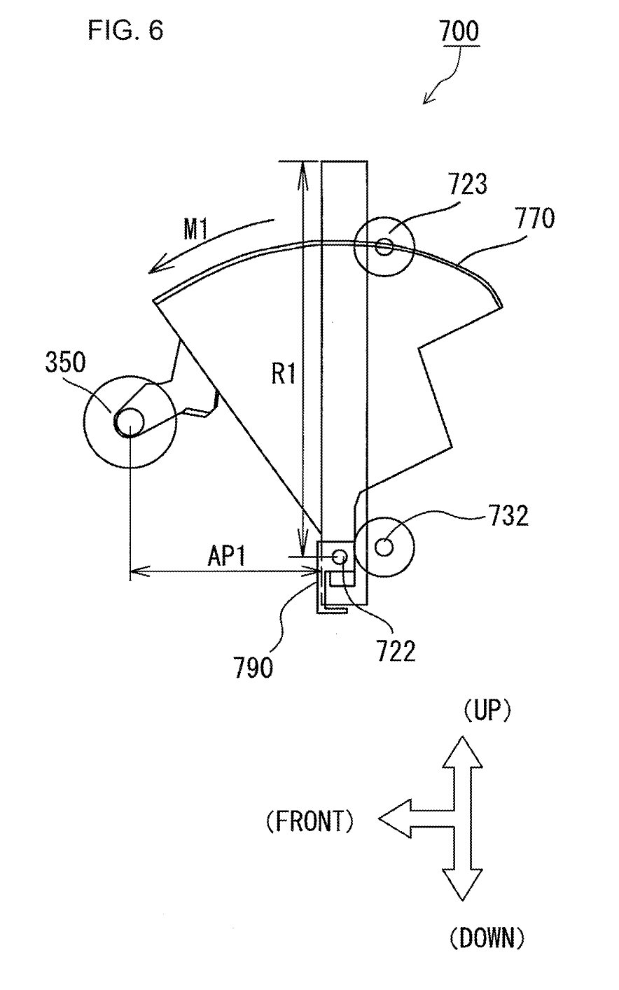

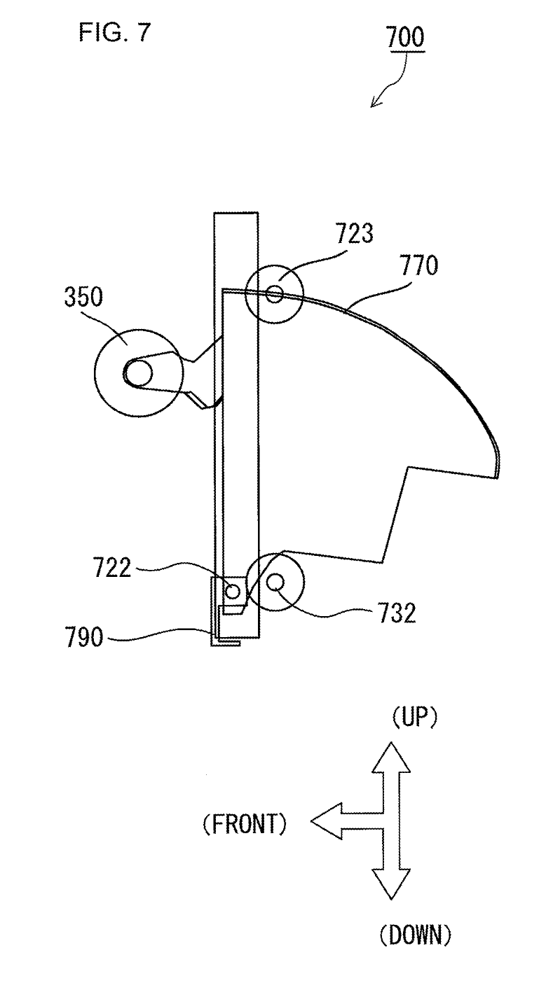

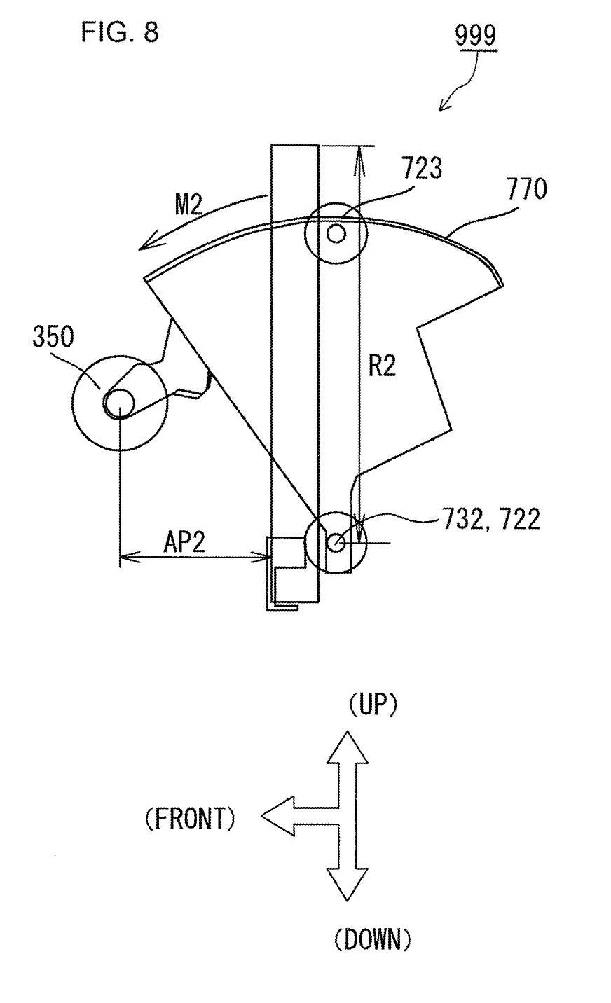

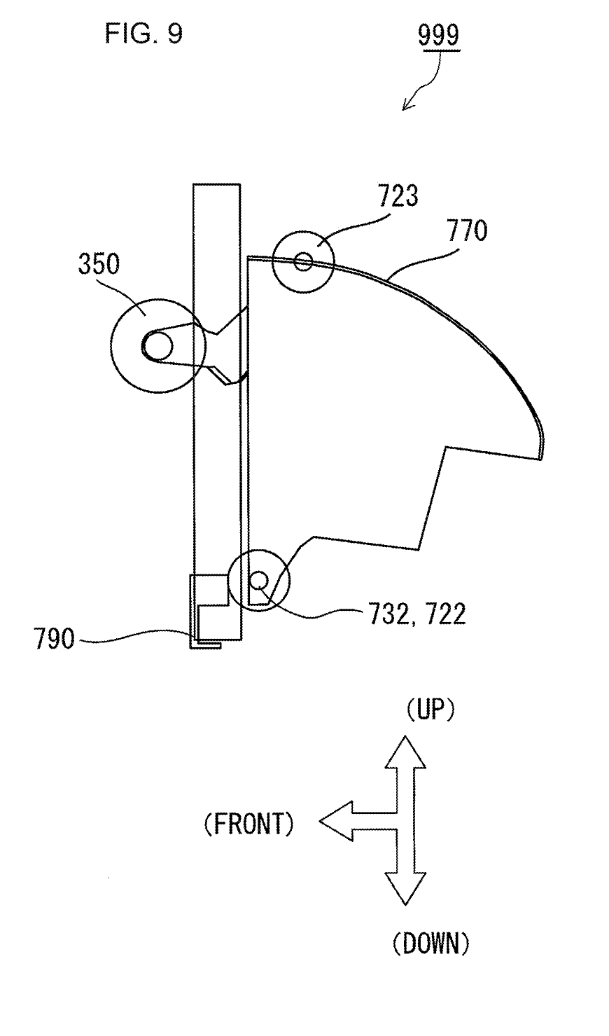

Each of FIGS. 6 and 7 is a schematic view showing one example of an outline of a state that the massage ball unit mechanism 770 protrudes from the massage unit 700 of the massage machine 100 according to this embodiment. Each of FIGS. 8 and 9 is a schematic view showing one example of an outline of a state that the massage ball unit mechanism 770 protrudes from a conventional massage unit 999. Each of FIGS. 6 and 8 shows the state that the massage unit mechanism 770 protrudes from the massage unit 700 or the massage unit 999 and each of FIGS. 7 and 9 shows a state that the massage ball unit mechanism 770 is contained in the massage unit 700 or the massage unit 999.

First, in the conventional massage unit 999, the up-and-down axis 732 and the forward-backward axis 722 are provided in a state that the up-and-down axis 732 and the forward-backward axis 722 are commonly used as an axis on the lower side of the massage ball unit mechanism 770 as shown in FIGS. 8 and 9. Further, as shown in FIG. 8, a distance from an upper end portion of the conventional massage unit 999 to the up-and-down axis 732 and the forward-backward axis 722 is a distance R2. Thus, the massage ball unit mechanism 770 pivotally moves in a direction of an arrowed line M2 around the up-and-down axis 732 and the forward-backward axis 722 due to the forward-backward motor 721 and the forward-backward rack and pinion mechanism 723. As a result, it is possible to obtain a protruding amount AP2 from the massage ball unit mechanism 770 to the pair of massage elements 350.

Next, as shown in FIGS. 6 and 7, in the massage unit 700 of the massage machine 100 according to this embodiment, the forward-backward axis 722 is provided on the front (FRONT) side and the lower (DOWN) side than the up-and-down axis 732 of the massage unit 700. Namely, the forward-backward axis 722 is provided at a position nearer to the side of the back of the person to be treated.

Since the forward-backward axis 722 is provided at the position differing from the up-and-down axis 732 on the front (FRONT) side and the lower (DOWN) side in this embodiment, a distance from the upper end portion of the massage unit 700 to the forward-backward axis 722 can be a distance R1 (R1>R2) as shown in FIG. 6. Thus, the massage ball unit mechanism 770 pivotally moves in a direction of an arrowed line M1 around the up-and-down axis 732 and the forward-backward axis 722 due to the forward-backward motor 721 and the forward-backward rack and pinion mechanism 723. As a result, it is possible to obtain a protruding amount AP1 (AP1>AP2) from the massage ball unit mechanism 770 to the pair of massage elements 350. Here, it is possible to make the protruding amount AP1 a value larger than the protruding amount AP2.

As shown in FIGS. 6 and 7, the protruding amount AP1 of the pair of massage elements 350 is larger than the protruding amount AP2. Further, as shown in FIG. 7, since the forward-backward axis 722 is pivotally supported by the inclusion preventive plate 790 which is conventionally provided, it is possible to prevent an increase in cost.

As described above, since the forward-backward axis 722 according to this embodiment is formed in parallel with the up-and-down axis 732 and provided nearer to the side of the body of the person to be treated than the up-and-down axis 732, it is possible to largely protrude the pair of massage elements 350 to the side of the body (the back) of the person to be treated.

Further, it is possible to pivotally support the forward-backward axis 722 with the inclusion preventive plate 790 which is used for preventing the inclusion of the cover member 320 when the massage unit 700 moves. As a result, it is possible to prevent an increase in cost.

Further, since the massage unit 700 can include the beating mechanism 740 and the kneading mechanism 750 and increase the protruding amount AP1 (>the protruding amount AP2), it is possible to efficiently provide a more desirable massage to the person to be treated.

(Correspondence Relationships among each Portion in the Embodiment and each Constituent Element in the Claims)

In the present invention, the massage machine 100 corresponds to “a massage machine”, the pair of massage elements 350 correspond to “a massage element and a pair of massage elements”, the forward-backward axis 722 corresponds to “a forward-backward axis”, the up-and-down axis 732 corresponds to “an up-and-down axis”, the massage unit 700 corresponds to “a massage unit”, the distance R1 corresponds to “a distance from the forward-backward axis to an uppermost end portions of a housing of the massage unit”, the distance R2 corresponds to “a distance from the up-and-down axis to the uppermost end portions of the housing of the massage unit”, the inclusion preventive plate 790 corresponds to “a member”, the seat portion 200 and/or the backrest portion 300 corresponds to “a body supporting portion”, the beating mechanism 740 corresponds to “a beating mechanism”, the kneading mechanism 750 corresponds to “a kneading mechanism”, the massage ball unit mechanism 770 corresponds to “a unit mechanism”, the lower side of the massage ball unit mechanism 770 corresponds to “one end side of the unit mechanism”, the upper side of the massage ball unit mechanism 770 corresponds to “the other end side of the unit mechanism”, the forward-backward rack and pinion mechanism 723 corresponds to “a rack and pinion mechanism”, the forward-backward motor 721 corresponds to “a forward-backward motor” and the up-and-down motor 731 corresponds to “an up-and-down motor”.

Although the preferred embodiment of the present invention is described above, the present invention is not limited thereto. It would be understood that a variety of embodiments can be practiced without departing from the spirit and scope of the present invention. Further, the functions and effects provided by the configuration of the present invention have been described in this embodiment, these functions and effects are merely one example and do not limit the present invention.

In the massage machine described in the patent document 1, an effect that a protruding amount of a massage ball can be significantly changed is provided.

As described above, in the patent document 1, it is possible to appropriately increase the protruding amount of the massage ball. However, it is required by the person to be treated that the protruding amount of the massage ball is further increased. However, it is difficult to further increase the protruding amount of the massage ball for the reason on the structure of the massage unit.

It is a primary object of the present invention to provide a massage unit and a massage machine which can increase the protruding amount of the massage ball.

(1) A massage unit according to one aspect, comprises a massage element; a forward-backward axis forming a swinging fulcrum point for moving the massage element forward or backward toward a body of a person to be treated; and an up-and-down axis provided so as to extend in a width direction thereof for moving the massage unit up and down, wherein the forward-backward axis is formed in parallel with the up-and-down axis and provided nearer to the side of the body of the person to be treated than the up-and-down axis.

In this case, since the forward-backward axis is formed in parallel with the up-and-down axis and provided nearer to the side of the body (the back) of the person to be treated than the up-and-down axis, it is possible to largely protrude the massage element toward the body (the back) of the person to be treated. Further, it is preferred that the forward-backward axis is provided on the lower side than the up-and-down axis.

(2) A massage unit according to a second present invention according to the massage unit of the one aspect, wherein a distance from the forward-backward axis to an uppermost end portion of a housing of the massage unit may be formed so as to be equal to or more than a distance from the up-and-down axis to the uppermost end portion of the housing of the massage unit.

In this case, since the distance from the forward-backward axis to the uppermost end portion of the housing of the massage unit is formed so as to be equal to or more than the distance from the up-and-down axis to the uppermost end portion of the housing of the massage unit, it is possible to increase a protruding amount of the massage element from the massage unit compared with the case where the up-and-down axis and the forward-backward axis are integrally provided. As a result, it is possible to allow the massage element to strongly contact with the back of the person to be treated.

(3) A massage unit according to a third present invention according to the massage unit of the one aspect or the second present invention, further comprises a member provided at an axis supporting portion pivotally supporting the up-and-down axis, and wherein both end sides of the forward-backward axis in a width direction thereof may be pivotally supported by the member.

In this case, it is possible to pivotally support the up-and-down axis with the member integrally provided at or attached to the axis supporting portion. The member may be a frame additionally having a function of preventing inclusion, for example. Conventionally, a preventive cover for preventing inclusion of a cloth at the time of moving the massage unit is provided. Thus, by pivotally supporting the forward-backward axis with the inclusion preventive cover, it is possible to reduce a cost required for providing a bearing constituted of a new member.

(4) A massage unit according to a fourth present invention according to the massage units of the one aspect to the third present invention, further comprises a unit mechanism including: a pair of massage elements providing a massage to the person to be treated, a beating mechanism allowing the pair of massage elements to perform a beating drive on the person to be treated, and a kneading mechanism allowing the pair of massage elements to perform a kneading drive on the person to be treated, and wherein a lower side (one end side) of the unit mechanism is pivotally supported by the forward-backward axis, and wherein a rack and pinion mechanism and a forward-backward motor are formed on an upper side (other end side) of the unit mechanism, and the unit mechanism may be swung by the forward-backward axis.

In this case, the pair of massage elements can beat the back of the person to be treated with the beating mechanism. Further, the pair of massage elements can perform an eccentric operation with the kneading mechanism to knead the back of the person to be treated. Furthermore, the one end portion of the unit mechanism is pivotally supported by the forward-backward axis and it is possible to protrude the unit mechanism with the rack and pinion structure. As a result, it is possible to largely protrude the unit mechanism itself around not the up-and-down axis but the forward-backward axis as an axis, thereby efficiently providing a massage to the person to be treated with the beating mechanism and the kneading mechanism.

(5) A massage machine according to another aspect comprises the massage unit defined by any one of claims 1 to 4; and an up-and-down motor interlocked and coupled with the up-and-down axis and elevating the massage unit along a body supporting portion for the person to be treated.

In this case, it is possible to elevate the massage unit in the massage machine including a seat portion and a backrest portion. Further, it is possible to increase the protruding amount of the pair of massage elements from the massage unit.

What is claimed is:

1. A massage unit, comprising:
a massage element;
a forward-backward axis forming a swinging fulcrum point for moving the massage element forward or backward toward a body of a person to be treated; and
an up-and-down axis provided so as to extend in a width direction thereof for moving the massage unit up and down,
wherein the forward-backward axis is formed in parallel with the up-and-down axis and provided nearer to the side of the body of the person to be treated than the up-and-down axis.

2. The massage unit according to claim 1, wherein a distance from the forward-backward axis to an uppermost end portion of a housing of the massage unit is formed so as to be equal to or more than a distance from the up-and-down axis to the uppermost end portion of the housing of the massage unit.

3. The massage unit according to claim 1, further comprising a member provided at an axis supporting portion pivotally supporting the up-and-down axis, and
wherein both end sides of the forward-backward axis in a width direction thereof are pivotally supported by the member.

4. The massage unit according to claim 1, further comprising a unit mechanism including:
a pair of massage elements providing a massage to the person to be treated,
a beating mechanism allowing the pair of massage elements to perform a beating drive on the person to be treated, and
a kneading mechanism allowing the pair of massage elements to perform a kneading drive on the person to be treated, and
wherein one end side of the unit mechanism is pivotally supported by the forward-backward axis, and
wherein a rack and pinion mechanism and a forward-backward motor are formed on the other end side of the unit mechanism, and the unit mechanism is swung by the forward-backward axis.

5. A massage machine, comprising:
the massage unit defined by claim 1; and
an up-and-down motor interlocked and coupled with the up-and-down axis and elevating the massage unit along a body supporting portion for the person to be treated.
